(19) United States
(12) Patent Application Publication
(10) Pub. No.: US 2021/0365565 A1
(43) Pub. Date: Nov. 25, 2021

(54) METHOD AND APPARATUS FOR DETECTING VULNERABILITY OF MULTI-LANGUAGE PROGRAM

(71) Applicant: SAMSUNG SDS CO., LTD., Seoul (KR)

(72) Inventors: Young Jun KUM, Seoul (KR); Yoon Chan JHI, Seoul (KR); Hee Cheol PARK, Seoul (KR)

(21) Appl. No.: 17/081,594

(22) Filed: Oct. 27, 2020

(30) Foreign Application Priority Data
May 21, 2020 (KR) 10-2020-0060944

(51) Int. Cl. G06F 21/57; G06F 21/56

(52) U.S. Cl. CPC G06F 21/577; G06F 2221/033; G06F 21/563

(57) ABSTRACT

A method for detecting vulnerability according to an embodiment includes performing taint analysis on a front-end source code generated with a first programming language of a program composed of the front-end source code and a back-end source code generated with a second programming language, generating a back-end call table including input parameter taint information for a called function called by the front-end source code among one or more back-end functions included in the back-end source code, based on a result of the taint analysis on the front-end source code, and performing taint analysis on the back-end source code based on the back-end call table.

### CROSS-REFERENCE TO RELATED APPLICATION

This application claims the benefit under 35 USC § 119(a) of Korean Patent Application No. 10-2020-0060944, filed on May 21, 2020, in the Korean Intellectual Property Office, the entire disclosure of which is incorporated herein by reference for all purposes.

### BACKGROUND

### 1. Field

The disclosed embodiments relate to technology for detecting vulnerability of a program.

### 2. Description of Related Art

Methods of inspecting software defects includes a testing technique that executes a code and finds defects based on the result value of execution and a code inspection technique that detects code defects that may occur during execution in advance by performing static analysis using only a source code.

Among these techniques, static analysis technique can shorten a development period and reduce a testing cost by removing the code defects before testing, and representative static analysis techniques include pattern inspection to find defects based on a structure of the code and a taint analysis technique based on data and control flow.

The taint analysis technique is a method of inspecting whether or not a tainted value is passed to a vulnerable function (sink) when the tainted value is input, and is a technique performed in the form of propagating that all values generated by using this value are tainted, and accuracy depends on maintaining and passing a correct taint state of the value.

However, an existing taint analysis technique supports only analysis on one specific programming language, and thus, for taint analysis on a program containing a source code generated with a plurality of programming languages, it is necessary to perform individual taint analysis on a source code part generated with each programming language using a taint analysis technique that supports each programming language. In this case, it is not possible to grasp data flow due to function calls between source codes generated with each programming language, and thus, there is a problem that analysis accuracy of the taint analysis is degraded.

### SUMMARY

The disclosed embodiments are intended to provide a method and apparatus for detecting vulnerability included in a multi-language program.

A method for detecting vulnerability according to an embodiment including performing taint analysis on a front-end source code generated with a first programming language of a program composed of the front-end source code and a back-end source code generated with a second programming language, generating a back-end call table including input parameter taint information for a called function called by the front-end source code among one or more back-end functions included in the back-end source code, based on a result of the taint analysis on the front-end source code, and performing taint analysis on the back-end source code based on the back-end call table.

The input parameter taint information may include identification information of the called function and one or more taint states of an input parameter of the called function.

The performing the taint analysis on the back-end source code may include identifying the called function among the one or more back-end functions by comparing identification information of each of the one or more back-end functions with the identification information of the called function and performing taint analysis on the identified called function based on each of the one or more of the taint states.

The performing the taint analysis on the identified called function may include performing the taint analysis on the identified called function by setting each of the one or more of the taint state as a taint state of a value passed as an input parameter of the identified called function.

The identification information of the called function may be determined based on a calling interface for calling the called function.

An apparatus for detecting vulnerability according to an embodiment including a front-end analysis unit configured to perform taint analysis on a front-end source code generated with a first programming language of a program composed of the front-end source code and a back-end source code generated with a second programming language, a call table generation unit configured to generate a back-end call table including input parameter taint information for a called function called by the front-end source code among one or more back-end functions included in the back-end source code, based on a result of the taint analysis on the front-end source code, and a back-end analysis unit configured to perform taint analysis on the back-end source code based on the back-end call table.

The input parameter taint information may include identification information of the called function and one or more taint states of an input parameter of the called function.

The back-end analysis unit may be further configured to identify the called function among the one or more back-end functions by comparing identification information of each of the one or more back-end functions with the identification information of the called function, and perform taint analysis on the identified called function based on each of the one or more of the taint states.

The back-end analysis unit may be further configured to perform the taint analysis on the identified called function by setting each of the one or more of the taint state as a taint state of a value passed as an input parameter of the identified called function.

The identification information of the called function may be determined based on a calling interface for calling the called function.

### BRIEF DESCRIPTION OF THE DRAWINGS

FIG. 1 is a block diagram of an apparatus for detecting vulnerability according to an embodiment.

FIG. 2 is a diagram illustrating an example of a front-end source code.

FIG. 3 is a diagram illustrating an example of a back-end source code including a back-end function called by the front-end source code illustrated in FIG. 2.

FIG. 4 is a flowchart of a method for detecting vulnerability according to an embodiment.

FIG. 5 is a block diagram illustratively describing a computing environment including a computing device according to an embodiment.

### DETAILED DESCRIPTION

Hereinafter, specific embodiments of the present invention will be described with reference to the accompanying drawings. The following detailed description is provided to aid in a comprehensive understanding of a method, a device and/or a system described in the present specification. However, the detailed description is only for illustrative purpose and the present invention is not limited thereto.

In describing the embodiments of the present invention, when it is determined that a detailed description of known technology related to the present invention may unnecessarily obscure the gist of the present invention, the detailed description thereof will be omitted. In addition, terms to be described later are terms defined in consideration of functions in the present invention, which may vary depending on intention or custom of a user or operator. Therefore, the definition of these terms should be made based on the contents throughout this specification. The terms used in the detailed description are only for describing the embodiments of the present invention and should not be used in a limiting sense. Unless explicitly used otherwise, an expression in a singular form includes a meaning of a plural form. In this description, expressions such as “including” or “comprising” are intended to indicate certain properties, numbers, steps, elements, and some or combinations thereof, and such expressions should not be interpreted to exclude the presence or possibility of one or more other properties, numbers, steps, elements other than those described, and some or combinations thereof.

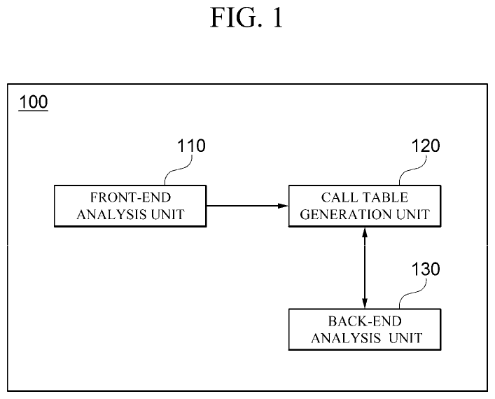

FIG. 1 is a block diagram of an apparatus for detecting vulnerability according to an embodiment.

Referring to FIG. 1, an apparatus 100 for detecting vulnerability according to an embodiment includes a front-end analysis unit 110, a call table generation unit 120, and a back-end analysis unit 130.

In the embodiment illustrated in FIG. 1, each of the front-end analysis unit 110, the call table generation unit 120, and the back-end analysis unit 130 may be implemented using one or more physically separated devices, or may be implemented by one or more hardware processors or a combination of one or more hardware processors and software, and unlike the illustrated example, these units may not be clearly distinguished in a specific operation.

In one embodiment, the apparatus 100 for detecting vulnerability is an apparatus for detecting vulnerability included in each of a front-end source code generated using a first programming language and a back-end source code generated using a second programming language by performing taint analysis on a program composed of the front-end source code and the back-end source code.

In this case, the back-end source code means a source code including one or more functions called by the front-end source code. Hereinafter, a ‘function’ is used as a concept including a ‘method’ of an object-oriented language.

Meanwhile, the first programming language and the second programming language may be two different programming languages selected from known programming languages, for example, Java, JavaScript, Python, C, C++, HyperText Markup Language 5 (HTML5), Advanced Business Application Programming (ABAP), etc. However, if a function included in a source code generated with a second programming language can be called in a source code generated with in a first programming language using a specific calling interface, the first programming language and the second programming language are not necessarily limited to a specific programming language.

The front-end analysis unit 110 performs taint analysis on the front-end source code.

Specifically, the front-end analysis unit 110 may perform taint analysis on the front-end source code by using one of various static taint analysis techniques that support taint analysis on the first programming language. That is, the taint analysis technique used for taint analysis on the front-end source code may be different according to embodiments, and is not necessarily limited to a specific taint analysis technique.

The call table generation unit 120 generates a back-end call table including input parameter taint information for a back-end function (hereinafter, referred to as ‘called function’) called by the front-end source code among one or more back-end functions included in the back-end source code, based on the result of taint analysis on the front-end source code.

In this case, according to an embodiment, the input parameter taint information on the called function may include identification information of the called function and one or more of taint states for the input parameter of the called function.

Specifically, the call table generation unit 120 may identify one or more back-end call points at which a back-end function is called in the front-end source code. In addition, the call table generation unit 120 may generate the back-end call table including the parameter taint information on the called function to be called at each back-end call point, based on the taint analysis result on the front-end source code.

According to an embodiment, the taint state for the input parameter is information for indicating whether or not a value passed as the input parameter of the called function is tainted when the called function is called by the front-end source code, for example, and may be one or more of ‘taint’, ‘suspect’, and ‘safety’. In this case, “taint” means that a value passed as an input parameter of the called function is a tainted value (e.g., an external input value such as a user input value, or a value generated from an external input value). In addition, ‘suspect’ means that the value passed as the input parameter of the called function is a value suspected of being tainted. In this case, the fact of being suspected of taint means that the value passed as the input parameter may be a tainted value or a safe value according to a condition (e.g., a condition described in a conditional sentence). Meanwhile, ‘safe’ means that the value passed as the input parameter of the called function is a safe value (that is, not a tainted value or value suspected of being tainted).

Meanwhile, when the same back-end function is called at a plurality of back-end calling points included in the front-end source code and taint states of the values passed as the input parameters of the called function at each back-end calling point are different from each other, the taint state included in taint information about the input parameter of the called function may be plural.

Meanwhile, according to an embodiment, identification information of the called function may include information for identifying the called function among one or more back-end functions included in the back-end source code.

Specifically, according to an embodiment, the identification information of the called function may be determined based on a calling interface used to call the back-end function included in the back-end source code in the front-end source code.

For example, when calling a back-end function included in a back-end source code generated using C++ in a front-end source code generated using Java, using Java Native Interface (JNI) as a calling interface, the identification information of the called function may include a class name and a method name of the called function.

As another example, when calling the back-end function included in the back-end source code generated using ABAP in the front-end source code generated using JavaScript, using Open Data protocol (OData) as the calling interface, the identification information of the called function may include at least some of information included in a Uniform Resource Identifier (URI) used for calling the called function in OData. Specifically, the URI used in OData is configured to have a structure such as “/sap/opu/odata/sap/{class name}/{method name}”, and the identification information of the called function may include the class name and method name included in the URI.

Meanwhile, the identification information of the back-end function included in the back-end call table is not necessarily limited to the example described above, and may differ according to the type of the call interface used.

The back-end analysis unit 130 performs taint analysis on the back-end source code based on the back-end call table.

Specifically, the back-end analysis unit 130 may perform taint analysis on the front-end source code using one of various static taint analysis techniques that support taint analysis on the second programming language. That is, the taint analysis technique used for taint analysis on the back-end source code may be different according to embodiments, and is not necessarily limited to a specific taint analysis technique.

Meanwhile, the back-end analysis unit 130 performs taint analysis on each of one or more back-end functions included in the back-end source code, but may perform taint analysis on the called function called by the front-end source code among one or more back-end functions based on the back-end call table.

According to an embodiment, the back-end analysis unit 130 may identify a called function called by the front-end source code among one or more back-end functions by comparing identification information of the called function included in the input parameter taint information of the back-end call table with identification information of each of one or more back-end functions included in the back-end source code.

In addition, according to an embodiment, the back-end analysis unit 130 may perform taint analysis on the called function, based on each of the one or more taint state for the input parameter of the called function included in the input parameter taint information. Specifically, the back-end analysis unit 130 may perform taint analysis on the called function by setting each of one or more taint states included in the input parameter taint information as a taint state of a value passed as an input parameter of the called function.

For example, when the taint state included in the taint information of the input parameter of the called function is ‘taint’ and ‘suspect’, the back-end analysis unit 130 may perform taint analysis for each of a case where a taint status of a value passed as an input parameter of a corresponding called function is ‘taint’ and a case where the taint status is ‘suspect’.

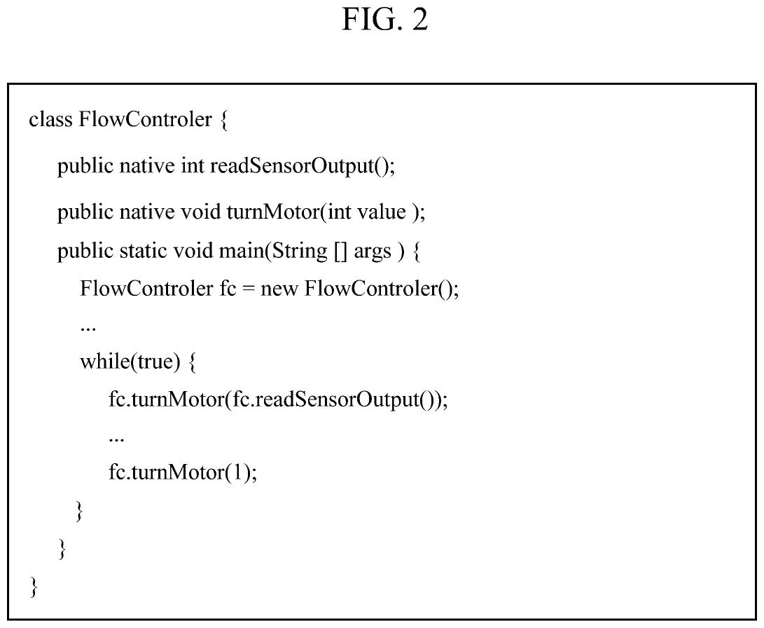

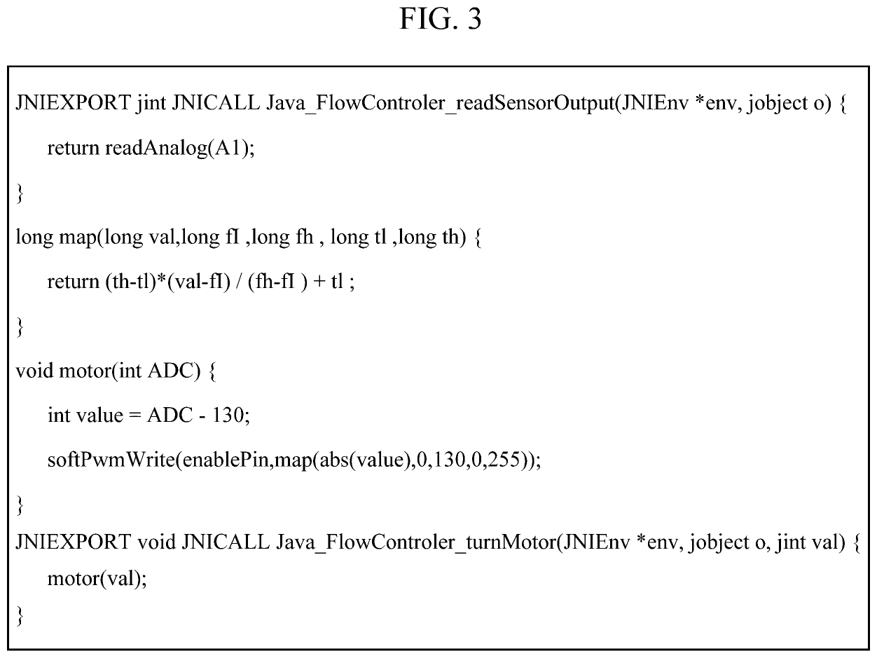

FIG. 2 is a diagram illustrating an example of a front-end source code generated with Java, and FIG. 3 is a diagram illustrating an example of a back-end source code generated with C++ and including a back-end function called by the front-end source code illustrated in FIG. 2.

In FIGS. 2 and 3, it is assumed that the back-end function is called using JNI.

Referring to FIG. 2, the back-end function ‘turnMotor’ included in the back-end source code is called at each of lines 8 and 10 of the front-end source code, and ‘readSensorOutput’ and ‘turnMotor’ written in line 8 are suspected of being a taint source and a sink, respectively, but since ‘turnMotor’ is implemented in the back-end source code, vulnerability in line 8 is not detected when performing taint analysis on the front-end source code.

Meanwhile, the apparatus 100 for detecting vulnerability may generate a back-end call table including input parameter taint information for a called function ‘turnMotor’ called at lines 8 and 10 of the front-end source code, based on a result of taint analysis for the front-end source code.

In this case, the input parameter taint information on ‘turnMotor’ may include the identification information of ‘turnMotor’ and the taint state of the value passed as the parameter of ‘turnMotor’ in lines 8 and 10 of the front-end source code. In addition, the identification information of ‘turnMotor’ may include ‘FlowControler’ which is a class name of ‘turnMotor’ and ‘turnMotor’ which is a method name.

Meanwhile, referring to FIG. 3, ‘readAnalog’ written in line 2 of the back-end source code and ‘motor’ written in line 12 are suspected of being a taint source and a sink, respectively, but since the input value of ‘motor’ is a value passed from the front-end source code, the vulnerability in line 12 is not detected only by taint analysis using the back-end source code itself.

Therefore, the apparatus 100 for detecting vulnerability may determine the taint state for the input parameter ‘val’ of the ‘turnMotor’ based on the input parameter taint information on the called function ‘turnMotor’ included in the back-end call table and perform taint analysis on ‘turnMotor’ included in the back-end source code.

Specifically, when ‘turnMotor’ is called at line 8 of the front-end source code, the value passed as the input parameter is an external input value, and when ‘turnMotor’ is called at line 10 of the front-end source code, the value passed as the input parameter is a constant. Accordingly, the input parameter taint information on ‘turnMotor’ included in the back-end call table may include two taint states of “taint” and “safe”

In this case, when performing taint analysis on ‘turnMotor’ included in the back-end source code, the apparatus 100 for detecting vulnerability may perform taint analysis for each of a case where a value passed as the input parameter ‘val’ is a tainted value and a case where the value is a safe value. In this case, when the value passed as ‘val’ is a tainted value, the tainted value is passed to the ‘motor’ which is a sink at line 12 of the back-end source code, and thus the apparatus 100 for detecting vulnerability detects line 12 as a vulnerable code.

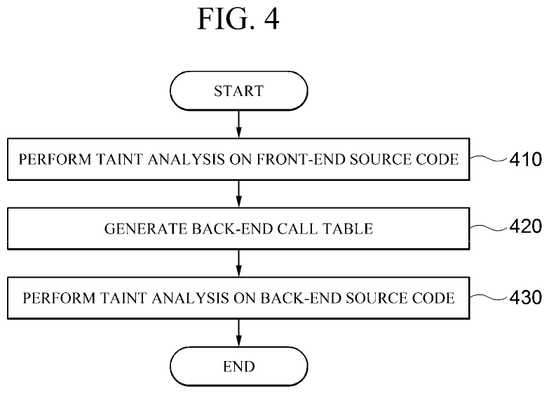

FIG. 4 is a flowchart of a method for detecting vulnerability according to an embodiment.

The method illustrated in FIG. 4 may be performed by the apparatus 100 for detecting vulnerability illustrated in FIG. 1.

Referring to FIG. 4, first, the apparatus 100 for detecting vulnerability performs taint analysis on the front-end source code generated with the first programming language (410).

Thereafter, the apparatus 100 for detecting vulnerability generates a back-end call table including input parameter taint information on the called function called by the front-end source code, among one or more back-end functions included in the back-end source code generated with the second programming language, based on the taint analysis result on the front-end source code (420).

In this case, according to an embodiment, the input parameter taint information may include identification information of the called function and one or more taint states of the input parameter of the called function.

Thereafter, the apparatus 100 for detecting vulnerability performs taint analysis on the back-end source code based on the back-end call table (430).

In this case, according to an embodiment, the apparatus 100 for detecting vulnerability may identify the called function called by the front-end source code among one or more back-end functions by comparing identification information of the called function included in the input parameter taint information of the back-end calling table with each of one or more back-end functions included in the back-end source code.

In addition, the apparatus 100 for detecting vulnerability may perform taint analysis on the identified called function, based on each of one or more taint states included in the input parameter taint information on the identified called function.

Meanwhile, in the flowchart illustrated in FIG. 4, at least some of the steps are performed in a different order, performed together by being combined with other steps, omitted, performed by being divided into detailed steps, or performed by being added with one or more steps (not illustrated).

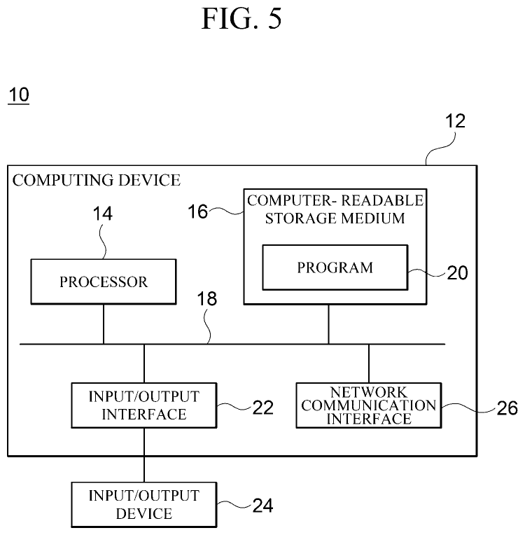

FIG. 5 is a block diagram for illustratively describing a computing environment 10 that includes a computing device according to an embodiment. In the illustrated embodiment, each component may have different functions and capabilities in addition to those described below, and additional components may be included in addition to those described below.

The illustrated computing environment 10 includes a computing device 12. In an embodiment, the computing device 12 may be one or more components included in the apparatus 100 for detecting vulnerability illustrated in FIG. 1.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. For example, the processor 14 may execute one or more programs stored on the computer-readable storage medium 16. The one or more programs may include one or more computer-executable instructions, which, when executed by the processor 14, may be configured to cause the computing device 12 to perform operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a voice or sound input device, input devices such as various types of sensor devices and/or photographing devices, and/or output devices such as a display device, a printer, a speaker, and/or a network card. The exemplary input/output device 24 may be included inside the computing device 12 as a component constituting the computing device 12, or may be connected to the computing device 12 as a separate device distinct from the computing device 12.

According to the disclosed embodiments, by providing taint information of a value passed from the front-end source code to the back-end source code based on a result of taint analysis on the front-end source code during taint analysis on the back-end source code, it is possible to improve the accuracy of taint analysis for a program generated with different programming languages.

Although the present invention has been described in detail through representative examples as above, those skilled in the art to which the present invention pertains will understand that various modifications may be made thereto within the limit that do not depart from the scope of the present invention. Therefore, the scope of rights of the present invention should not be limited to the described embodiments, but should be defined not only by claims set forth below but also by equivalents of the claims.

What is claimed is:

1. A method for detecting vulnerability comprising:
performing taint analysis on a front-end source code generated with a first programming language of a program consisting of the front-end source code and a back-end source code generated with a second programming language;
generating a back-end call table including input parameter taint information for a called function called by the front-end source code among one or more back-end functions included in the back-end source code, based on a result of the taint analysis on the front-end source code; and
performing taint analysis on the back-end source code based on the back-end call table.

2. The method of claim 1, wherein the input parameter taint information includes identification information of the called function and one or more taint states of an input parameter of the called function.

3. The method of claim 2, wherein the performing the taint analysis on the back-end source code comprises:
identifying the called function among the one or more back-end functions by comparing identification information of each of the one or more back-end functions with the identification information of the called function, and
performing taint analysis on the identified called function based on each of the one or more of the taint states.

4. The method of claim 3, wherein the performing the taint analysis on the identified called function comprises performing the taint analysis on the identified called function by setting each of the one or more of the taint state as a taint state of a value passed as an input parameter of the identified called function.

5. The method of claim 2, wherein the identification information of the called function is determined based on a calling interface for calling the called function.

6. An apparatus for detecting vulnerability comprising:
a front-end analysis unit configured to perform taint analysis on a front-end source code generated with a first programming language of a program consisting of the front-end source code and a back-end source code generated with a second programming language;
a call table generation unit configured to generate a back-end call table including input parameter taint information for a called function called by the front-end source code among one or more back-end functions included in the back-end source code, based on a result of the taint analysis on the front-end source code; and
a back-end analysis unit configured to perform taint analysis on the back-end source code based on the back-end call table.

7. The apparatus of claim 6, wherein the input parameter taint information includes identification information of the called function and one or more taint states of an input parameter of the called function.

8. The apparatus of claim 7, wherein the back-end analysis unit is further configured to identify the called function among the one or more back-end functions by comparing identification information of each of the one or more back-end functions with the identification information of the called function, and perform taint analysis on the identified called function based on each of the one or more of the taint states.

9. The apparatus of claim 8, wherein the back-end analysis unit is further configured to perform the taint analysis on the identified called function by setting each of the one or more of the taint state as a taint state of a value passed as an input parameter of the identified called function.

10. The apparatus of claim 7, wherein the identification information of the called function may be determined based on a calling interface for calling the called function.
